(19) United States
(12) Patent Application Publication
(10) Pub. No.: US 2007/0098514 A1
(43) Pub. Date: May 3, 2007

(54) Method and apparatus for securing an article in a containment chamber

(76) Inventor: Matthew Adams, Jacksonville, FL (US)

Correspondence Address: PILLSBURY WINTHROP SHAW PITTMAN LLP, P.O. BOX 10500, MCLEAN, VA, 22102, US

(21) Appl. No.: 11/266,006

(22) Filed: Nov. 2, 2005

(51) Int. Cl. B60P 3/06

(52) U.S. Cl. 410/23

(57) ABSTRACT

The present invention is directed to methods and apparatus for securing an article in a transportable container. The apparatus includes a chock assembly that is adjustable and allows the chock assembly to be secured by friction forces between two opposite sidewalls of a transportable container. In one implementation, chock assemblies are provided to assist in securing the front and rear wheels of a vehicle within the transportable container. In a preferred aspect, the chock assemblies include spaced apart first and second frame members that are adjustable with respect to one another, thereby providing an adjustable substantially parallel distance therebetween. Methods according to the present invention are provided for securing an article in a transportable container including adjusting an adjustable frame into a secure position between two opposite sidewalls of a transportable container using friction forces and securing the article in a fixed position relative to the adjustable frame.

### FIELD OF THE INVENTION

The present invention relates to a method and apparatus for securing an article in a containment chamber. In a particular implementation, the present invention relates to a chock assembly and a method for using the same.

### BACKGROUND OF THE INVENTION

There are many known types of containment chambers. Certain types of containment chambers are used exclusively for holding certain types of goods—such a vehicle carriers that transport new cars by train or truck and have tracks along with other mechanisms to hold the vehicles in predetermined positions. Other types of containment chambers are of general purpose, being used to hold various types of articles. Examples of such containment chambers are shipping containers, railroad cars and all-purpose carriers, both closed i.e. having walls and a ceiling in addition to a floor) and open having opening on the sides, with or without a ceiling), which can be separate from or attached to, a vehicle, typically a truck.

Certain containment chambers are manufactured in a manner that makes them adaptable to storing a greater variety of articles. In addition to having the appropriate structural supports that allow certain containment chambers to hold heavier loads than others, the number of internal fasteners can vary. Some containers have many different types of fasteners, such as D-rings and the like, to hold articles in place, whereas others will have almost no areas that can be used to hold articles in place.

The types of goods that containment chambers will carry can also vary considerably. Certain articles are already palletized or placed in arrangements that allow them not only to be placed on the floor of the chamber, but also in relative positional relationships with other articles to assist in keeping them in place. Other articles, such as vehicles, must be positioned in a manner that ensures they do not touch each other, as any contact between them would damage them. Vehicles have additional issues that must be considered when being moved. In particular, vehicles have wheels, tracks or other movement mechanisms, in which only a small surface area the wheel bottom or the track bottom for instance) actually touches the floor of the containment chamber. With their typically excessive weight, vehicles are therefore more susceptible to undesired movements when being transported.

When transporting vehicles in containment chambers, if the containment chamber has a variety of different fasteners, particularly D-rings on the floor of the chamber, it is known to use such fasteners to tie down a chock, which can then provide support to assist in keeping the vehicle in its desired position. While this method and system work in certain circumstances, the positional relationship of the D-ring fasteners must correspond with the positional relationship of the wheelbase of the vehicle in order to work effectively. Since wheelbases can vary considerably, as can the spacings of fasteners in containment chambers, this results in considerable logistics overhead to ensure that the correct containment chamber is in place where the particular vehicle is that needs transport.

Accordingly, in order diminish this logistics overhead, to assist in securing articles of many different types in containment chambers, as well as to provide other advantages that are apparent herein, the present invention is provided.

### SUMMARY OF THE INVENTION

The present invention includes methods and apparatus for securing an article in a transportable container.

According to one aspect of the invention, the apparatus includes a chock assembly that is adjustable and allows the chock assembly to be secured by friction forces between two opposite sidewalls of a transportable container. The apparatus also preferably includes a strap fasteners and strap assemblies connected to the strap fasteners to assist in holding the article in position relative to the rigid member.

According to another aspect of the invention, chock assemblies are provided to assist in securing the front and rear wheels of a vehicle within the transportable container. In a preferred aspect, the chock assemblies include spaced apart first and second frame members that are adjustable with respect to one another, thereby providing an adjustable substantially parallel distance there between.

In yet another aspect of the invention, methods are provided for securing an article in a transportable container including adjusting an adjustable frame into a secure position between two opposite sidewalls of a transportable container using friction forces and securing the article in a fixed position relative to the adjustable frame,

The present invention further includes methods of securing an article in a transportable container that does not include internal fasteners within the transportable container.

### BRIEF DESCRIPTION OF THE DRAWINGS

These and other aspects and features of the present invention will become apparent to those of ordinary skill in the art upon review of the following description of specific embodiments of the invention in conjunction with the accompanying figures, wherein:

FIG. 1a illustrates an embodiment of the invention;

FIGS. 1b and 1c illustrate implementations of the FIG. 1a embodiment according to the present invention; and

FIG. 2a-2g illustrate another embodiment of the invention.

### DETAILED DESCRIPTION OF THE PREFERRED EMBODIMENTS

A transport securing assembly 100 is provided for securing many different types of articles, and preferably many different types of vehicles, including cars, vans, trucks, construction equipment, farming equipment, and the like inside a container 170 The transport securing assembly 100 is comprised of an frame 110, a side stop assembly 120/130 and a tie down strap assembly 140.

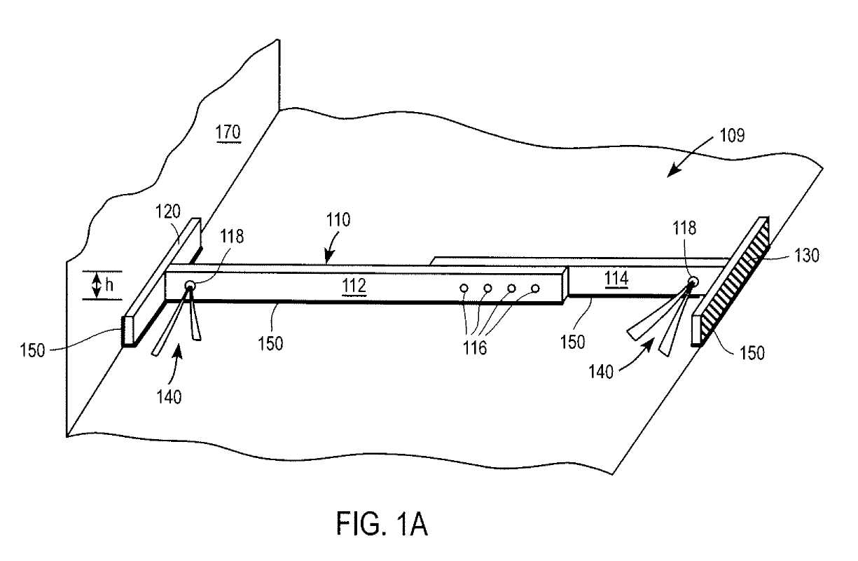

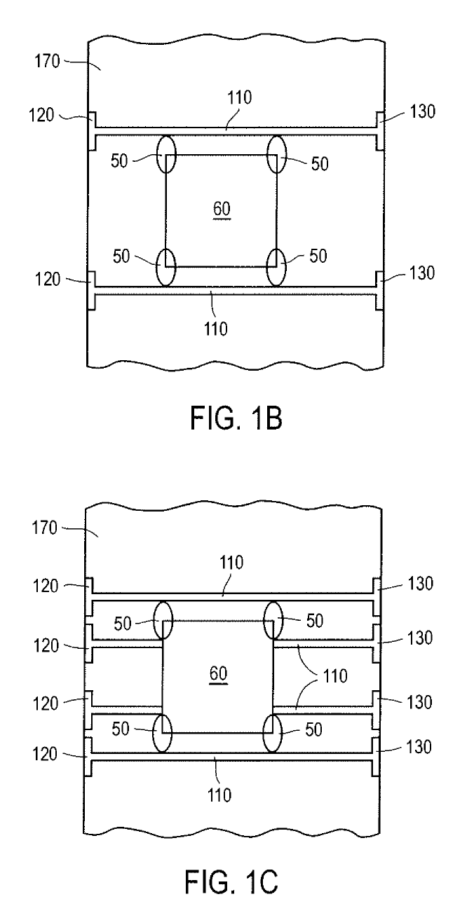

FIG. 1A illustrates a simplified version of the assembly 100. As illustrated, the frame 110 is made of rigid material, such as aluminum, composite, steel or the like, having a height “h” that is also sufficient to operate as a chock for a vehicle, or, alternatively, a support for an article placed against it. On each side of the frame 110 is a side stop assembly, shown as side stops 120 and 130. The side stops operate to create friction against lower opposite sides of the containment chamber when the assembly 100 is fully set-up. The set-up includes adjusting the frame so that the side-stops are engaged by friction against each of the lower opposite sides of the containment chamber. In the embodiment shown in FIG. 1, this is accomplished by having the frame 110 have pieces 112 and 114, with holes 116 formed through both, which allows the length of the frame to adjust, and then be kept in that position using a bolt or other fastener through some of the aligned holes 116. Further, so that a contiguous and flat surface presents itself across the entire frame 110, another piece (not illustrated) can be between the end of either pieces 112 and 114 and 130 and 120, respectively.

Also included as part of the assembly 100 is a strap fastener 102, which can be a hole or a ring attached to the member 110 or some other like fastening device, is disposed substantially at each of the two ends of the of the rigid member 110. Each strap fastener 118 is provided for the insertion therein of a tie down strap assembly 140, which can be used to attach to the article, such as a wheel of a vehicle. Thus, each strap assembly 140 is connectable to one of the strap fasteners 118 and adapted to assist in holding the article in position relative to the rigid member 110.

In the above described as well as all other embodiment, it is preferable to have a heavy duty rubberized material underside 150 on the underside of frame 110, as well as the underside and sides of side stops 120/130, in order to keep them in a stationary position once set-up in place.

FIG. 1B illustrates placement of two assemblies 100 inside a containment chamber, so that each operates to maintain one of the front and rear sets of wheels 60 of a vehicle 50 in position. FIG. 1C illustrates the usage of four assemblies 100 inside a containment chamber, so that a pair operate together to maintain one of the front and rear sets of wheels 60 of a vehicle 50 in position. It will be appreciated that the FIG. 1C implementation more closely replicates the embodiment described by the assembly 200 hereinafter, and that certain aspects of the assembly 200 described hereinafter can be used in the assembly 100, and that not all of the specific aspects of the embodiment described by the assembly 200 are necessary in all instances.

For smaller vehicles being secured, two vehicles with wheelbases that are the same could be secured side-by-side.

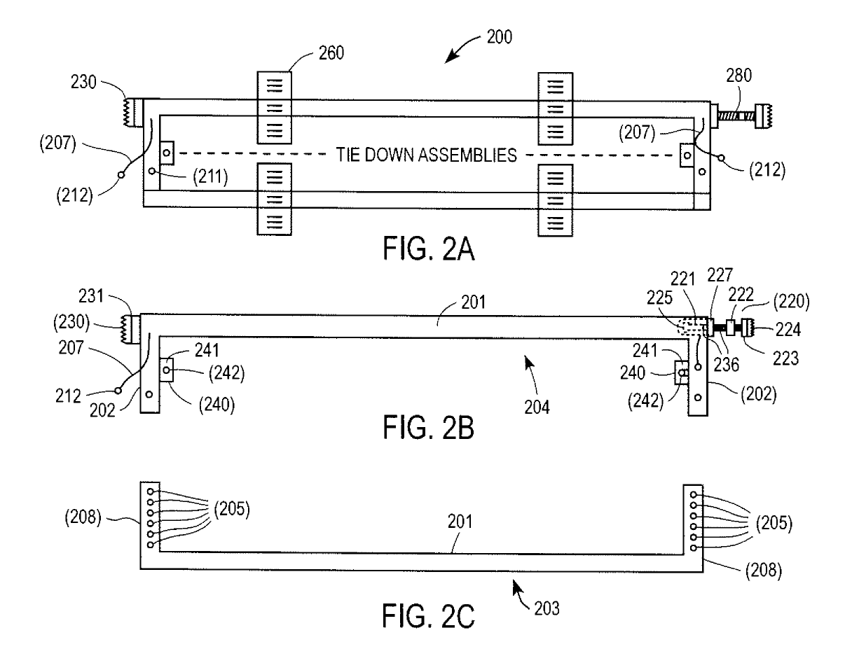

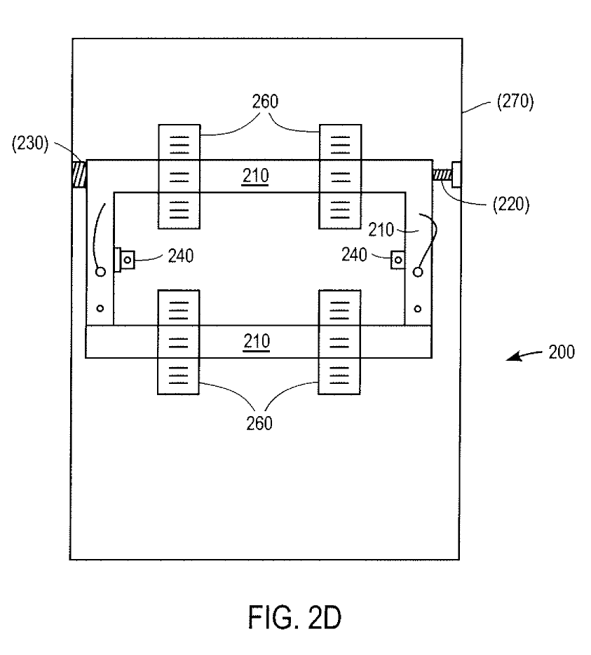

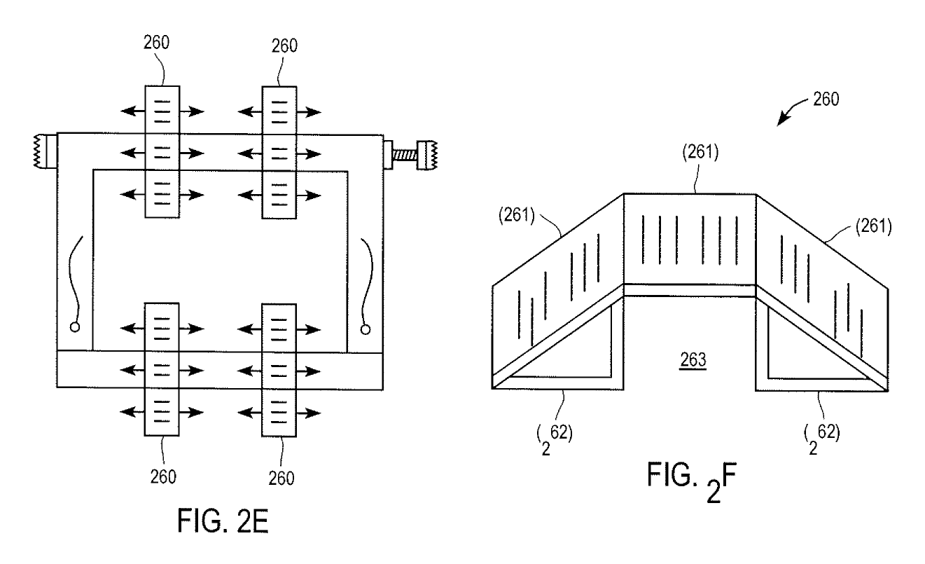

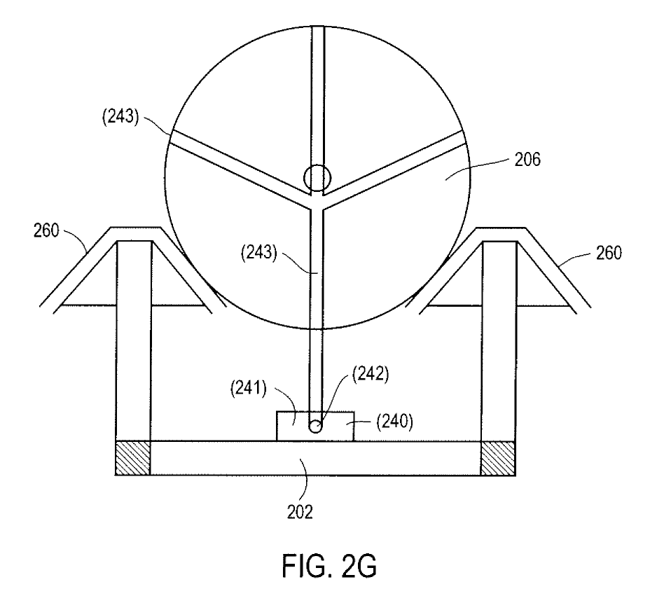

Further refinements can be made to the system 100 that allow for further advantages in the ability to secure an article, preferably a vehicle with wheels, in place, as shown in FIGS. 2a-2g.

As shown in FIGS. 2a-2c, a particular transport securing assembly 200 is constructed of two “U” pieces. One “U” piece is the receiving frame 204 and the other “U” piece is the adjustable frame piece 203. Each “U” piece is comprised of a single main beam 201 and two arms. The arms 202 of the receiving frame 204 are preferably longer than the arms 208 of the adjustable frame piece 203. The arms 202 and 208 are attached, typically by being fastened with a fastener of some type, like a bolt, though they could be a unitary piece formed by welding to the main beams 201. With a substantially 90 degree angle formed on both ends, the arms 202 and 208 and the main beam 201 form a “U” shaped piece. Each “U” piece preferably has a heavy-duty rubberized material underside 250 to prevent the movement of the transport securing assembly 200. The adjustable frame piece 203 slides into the receiving frame 204 and they are pinned together via a retaining pin 212 or some other type of fastening element that passes through the receiving frames' 204, alignment holes 211 into one of the adjustment holes 205 on the adjustable frame piece 203. The retaining pin 212 is preferably secured to the receiving frame 204, such as by means of a lanyard 207, so it does not get lost. The use of the adjustment holes 205 allow for the width of the entire transport securing assembly 200 to be changed. This allows the transport securing assembly 200 to accommodate various sized articles (typically wheels) 206. The main beams 201 of both the receiving frame 204 and the adjustable frame piece 203 are made out of a rigid material, preferably a material that is both strong and lightweight, such as 6061 Aircraft Aluminum tubes. The arms 208 on the adjustable frame piece 203 and the arms 202 of the receiving frame 204 are preferably made out of the same materials. The adjustment holes 205 are located on, preferably directly in the center of the middle, of both arms 208 of the adjustable frame piece 203. The alignment holes 211 are located on, preferably directly in the center of the middle of, both arms 202 of the receiving frame 204. The alignment holes 211 are located towards the end of the arms 202 of the receiving frame 204 in order to allow the adjustment capability of the transport securing assembly 200.

At one of the receiving frame's 204 main beam 201 is a fixed stop side stopper assembly 230. The fixed side stop stopper 230 is comprised of a base support piece 231 manufactured of rigid material, typically the same material used for the member 210 Attached on the outside of the base support piece 231 is a rubberized surface material 232. The rubberized surface material 232 will push up against the side/walls of the container 270 and create friction to keep the assembly 200 in place. The rubberized surface material 232 thus supplies both friction and suction to the side/walls of the container 270 wall to prevent movement of the transport securing assembly 200.

Opposite to the fixed stop assembly 230 on the receiving frame's 204 main beam 201 is an adjustable side stop assembly 220. The adjustable side stop assembly 220 can be adjusted in a variety of manners, such as using a threaded rod 221, an adjustment nut 222, a rigid, such as aluminum but even more preferably steel plate 223, a rubberized end plate 224, an internal stopper plate 225, a guide pipe 226, and an end plate 227.

At the end of the threaded rod 221 that is not inside the receiving frame 204 is the plate 223 that is affixed to the threaded rod 221. On the other outside side of the plate 223, a heavy duty rubberized material is used to push up against the side/wall of the container 270. The threaded rod 221 is guided inside the receiving frame's 204 main beam 201 by the guide pipe 226 to keep it perpendicular to the side/wall of the container 270. The end plate 227 is affixed to the outside of the receiving frame 204 and to the guide pipe 226 to add stability to the guide pipe 226. As the adjustment nut 222 is turned on the threaded rod 221 it will eventually rest up against the exposed part of the guide pipe 226. As the adjustment nut 222 keeps the extended threaded rod 221 in position. Once the desired tension is reached between the plate 223 (including the heavy rubberized material 232) against the container's side/wall 271, the transport securing assembly 200 will be stabilized to prevent movement of the transport securing assembly 200 The internal stopper plate 225 is affixed to the threaded rod 221 on the end that is inside the receiving frame 204. The internal stopper plate 225 stops the threaded rod 221 from totally coming out of the receiving frame 204.

As also shown in FIGS. 2E and 2F, rather than have chocks that are essentially the rigid member, there exists individual, adjustable chocks 260 made out of a rigid, preferably lightweight, material, such as 6061 Aircraft Aluminum that are used to allow the vehicle/equipment to drive into the transport securing assembly 200, drive out of the transport securing assembly 200, and keep the vehicle/equipment inside the transport securing assembly 200 during transport and therefore secure the vehicle/equipment during transport. If it is not a vehicle, but instead an article, the chocks 260 can be configured to have a shape that corresponds to the article of interest. For example, a smooth side surface for a flat sided article.

The individual adjustable chocks 260 are manufactured by welding a rigid lightweight material, such as 6061 Aircraft cleated aluminum cleats 261 at some angle, (such as 45 degrees) in the front and rear and above two structure tubes 262, which are made of a rigid material such as lightweight 6061 Aircraft Aluminum. The structure tubes 262 are preferably cut diagonally across the length of the tube. Further, grit may be disposed on the cleats 261 for added traction The assembly of the components that make up an individual, adjustable chock 260 creates an inside pocket 263 that allows the chocks 260 to slide laterally along the main beams 201 of the adjustable frame piece 203 and the receiving frame 204 to accommodate for different distances, particularly for different distances between wheels of a vehicle.

A tie down strap assembly 240 is attached to the arm 202 of the frame 204, as shown in FIG. 2G. This assembly 240 includes a tie down plate 241 that that has a tie down opening 242 through which tie down straps 243 can be affixed to secure the article, such as the wheel 206 of the vehicle in place and therefore also help secure the vehicle/equipment during transport.

Usage of the system 200 within a containment chamber for purpose of securing a vehicle with wheels therein is the same as that illustrated in FIG. 1c. It is understood that other articles could be secured therein, but that the present invention has certain specific advantages to securing vehicles in containment chambers that do not have any other internal fasteners therein. As such, the wheels rest within the frame, with the chocks being used to assist in allowing the wheels to initially position, stay in place during transport, and then exit when transport is finished.

Although the present invention has been particularly described with reference to embodiments thereof, it should be readily apparent to those of ordinary skill in the art that various changes, modifications and substitutes are intended within the form and details thereof, without departing from the spirit and scope of the invention. Accordingly, it will be appreciated that in numerous instances some features of the invention will be employed without a corresponding use of other features. Further, those skilled in the art will understand that variations can be made in the number and arrangement of components illustrated in the above figures. It is intended that the scope of the appended claims include such changes and modifications.

What is claimed:

1. An apparatus for securing an article in a fixed position within a transportable container, the transportable container including a floor and two opposite sidewalls disposed a distance from each other, the apparatus comprising:
a chock assembly adapted to be removably secured within the adjustable container, the chock assembly comprising:
an adjustable rigid member having two ends, with each of the two ends having a stop member associated therewith, wherein, when the chock assembly is positioned on the floor of the transportable container, the adjustable rigid member and stops secure by friction forces the chock assembly within the transportable container between the two opposite sidewalls;
a strap fastener disposed substantially at each of the two ends of the of the rigid member; and
two strap assemblies, each strap assembly connected to one of the strap fasteners to assist in holding the article in position relative to the rigid member.

2. The apparatus according to claim 1 wherein:
the article is a vehicle with front and back wheels;
the chock assembly secures one of the front and back wheels of the vehicle in position relative to the rigid member; and
further including a second chock assembly that secures the other of the front and back wheels of the vehicle in position relative to a second rigid member having two ends, the second chock assembly further including:
a second adjustable rigid member having two ends, with each of the two ends having a second stop member associated therewith, wherein, when the second chock assembly is positioned on the floor of the transportable container, the second adjustable rigid member and second stop members secure by friction forces the second chock assembly within the transportable container between the two opposite sidewalls;
a second strap fastener disposed substantially at each of the two ends of the of the rigid member; and
two second strap assemblies, each second strap assembly connectable to one of the second strap fasteners and adapted to assist in holding the vehicle in position relative to the second rigid member.

3. The apparatus according to claim 1 wherein the rigid member comprises: first and second frame members that are substantially parallel to each other; and
first and second chocks connected to at least one of the first and second frame members, the first and second chocks further assisting in holding the article in position between the first and second frame members.

4. The apparatus according to claim 3 wherein the article is a vehicle with front and back wheel sets, and the first and second chocks assisting in holding one of the front and back wheel sets in position relative to the rigid member.

5. The apparatus according to claim 3 wherein the first and second chocks are slidably moveable within at least one of the first and second frames.

6. The apparatus according to claim 3 further including third and fourth chocks connected to the other of the first and second frame members, the third and fourth chocks further assisting in holding the article in position between the first and second frame members.

7. The apparatus according to claim 3 wherein the first and second frame members are adjustable with respect to one another, thereby providing an adjustable substantially parallel distance therebetween.

8. The apparatus according to claim 7 wherein each of the first and second frame members have first and second end piece attached at opposite ends thereof
each of the first and second end pieces have a plurality of spaced-apart holes formed therein; and
wherein a fastener protrudes through aligned spaced-apart holes on one end piece from each of the first and second frame members, thereby providing an adjusted substantially parallel distance therebetween.

9. The apparatus according to claim 1 wherein a bottom of the rigid member includes a friction-creating surface.

10. The apparatus according to claim 9 wherein the friction-creating surface is rubber connected to the rigid member.

11. The apparatus according to claim 1 wherein the stop members include an adjustable stop member and another stop member, and wherein the adjustable rigid member is adjustable using the adjustable stop member, such that the adjustable stop member telescopes to secure the chock assembly within the adjustable container.

12. The apparatus according to claim 11 wherein the friction-creating surface is rubber connected to the adjustable stop member and the another stop member.

13. The apparatus according to claim 12 wherein the another stop is a fixed stop.

14. The apparatus according to claim 13 wherein a bottom of the rigid member includes a friction-creating surface.

15. The apparatus according to claim 14 wherein the friction-creating surface is rubber connected to the rigid member.

16. The apparatus according to claim 11 wherein the adjustable stop and the another stop each have a side surface having a length that extends beyond parallel support beams associated with the transportable container.

17. The method according to claim 11 wherein the rigid member, the adjustable stop and the another stop are made from aluminum.

18. The method according to claim 1 wherein the rigid member comprises aluminum.

19. A method of securing an article in a transportable container, the transportable container including two opposite sidewalls disposed a distance from each other, the method comprising the steps of:
adjusting an adjustable frame between the two opposite sidewalls, whereby friction forces between opposite ends of the adjustable frame and the two opposite sidewalls keep the adjustable frame in a removably secured position within the transportable container; and
securing an article in a fixed position relative to the adjustable frame, the step of securing using the adjustable frame and a strap assembly to provide the securing.

20. The method according to claim 19 wherein the article is a vehicle with front and back wheels; and wherein
the step of adjusting adjusts a second adjustable frame between the two opposite sidewalls, whereby friction forces between opposite ends of the second adjustable frame and the two opposite sidewalls keep the second adjustable frame in a removably secured position within the transportable container; and
the step of securing secures the vehicle in the fixed position relative to the adjustable frame, the step of securing using the adjustable frame and the strap assembly to secure one of the front and back wheels and the second adjustable frame and a second strap assembly to secure the other of the front and back wheels.

21. The method according to 20 wherein the step of adjusting further includes adjusting slideably moveable chocks associated with each of the adjustable frame and the second adjustable frame, the slideably moveable chocks being aligned with wheels that are associated with the article.

22. The method according to claim 21 wherein the step of adjusting further includes adjusting a spacing of first and second frame members associated with each of the adjustable frame and the second adjustable frame, thereby providing an adjustable substantially parallel distance therebetween.

23. The method according to claim 19 wherein the opposite ends have a predetermined length, and wherein the step of adjusting positions the predetermined length to span adjacent parallel support beams associated with the transportable container.

24. The method according to claim 19 wherein the step of securing is performed in a transportable container that has a smooth floor devoid of attachment mechanisms.

25. An apparatus for securing an article in a transportable container, the transportable container including a smooth floor devoid of attachment mechanisms and two opposite sidewalls disposed a distance from each other, the apparatus comprising:
adjustable frame means disposed between the two opposite sidewalls removably securing the frame means between the two opposite sidewalls within the transportable container; and
means for securing the article in a fixed position relative to the adjustable frame means.

26. The apparatus according to claim 25 wherein the article is a vehicle with front and back wheels; and wherein
the adjustable frame means includes a first adjustable frame disposed between the two opposite sidewalls, whereby friction forces between opposite ends of the first adjustable frame and the two opposite sidewalls keep the first adjustable frame in a removably secured position within the transportable container; and
the means for securing secures the vehicle in the fixed position relative to the adjustable frame includes a first strap assembly to secure one of the front and back wheels to the first adjustable frame.

27. The apparatus according to claim 26 wherein
the adjustable frame means further includes a second adjustable frame disposed between the two opposite sidewalls, whereby friction forces between opposite ends of the second adjustable frame and the two opposite sidewalls keep the second adjustable frame in a removably secured position within the transportable container; and
the means for securing further includes a second strap assembly to secure the other of the front and back wheels to the second adjustable frame.

28. The apparatus according to 25 wherein the means for adjusting further includes adjusting slideably moveable chocks, the slideably moveable chocks being aligned with wheels that are associated with the article.

29. The apparatus according to claim 25 wherein the means for adjusting further includes means for adjusting a spacing of first and second frame members associated with the adjustable frame, thereby providing an adjustable substantially parallel distance therebetween.

30. The apparatus according to claim 25 wherein the frame means includes two opposite ends each having a predetermined length that spans adjacent parallel support beams associated with the transportable container.
